(19) United States
(12) Patent Application Publication
(10) Pub. No.: US 2022/0121163 A1
(43) Pub. Date: Apr. 21, 2022

(54) METHOD FOR VISUALIZING THE AUTOMATION OF A TECHNICAL SYSTEM

(71) Applicant: LENZE SE, Aerzen (DE)

(72) Inventor: Michael May, Hameln (DE)

(73) Assignee: LENZE SE, Aerzen (DE)

(21) Appl. No.: 17/293,510

(22) PCT Filed: Nov. 15, 2019
(86) PCT No.: PCT/EP2019/081512

§ 371 Date: Dec. 20, 2021

(30) Foreign Application Priority Data
Nov. 16, 2018 (DE) 10 2018 128 915.4

(51) Int. Cl. G05B 19/042; B25J 13/06; B25J 9/16

(52) U.S. Cl. CPC G05B 19/042; G05B 2219/40269; B25J 9/1664; B25J 13/06

(57) ABSTRACT

The invention relates to a method for visualizing the automation of a drive system for a technical system, wherein the technical system consists of a plurality of modules. Module type data objects that are assigned to module types are stored in a data storage device, wherein the module type data objects include a graphical representation of the module type data relating to the particular module types. First, the module types of the modules of which the technical system is composed are selected by a user via a user interface. Module data objects assigned to the modules are generated by means of a data processing device, which module data objects contain module data, wherein the module data contain data relating to the graphical representation of the module type of each module, and wherein a data processing device generates a visualization of the assembled technical system based on the module data, which visualization is presented to the user by means of a visualization device, in particular a display.

### TECHNICAL FIELD

The invention relates to a method for visualizing the automation of a technical system and to a visualization system and to a computer program product.

### BACKGROUND

In many situations, it is appropriate to be able to form a visual representation of a technical system such as for example a complex machine, a production line, a robot arm or the like. These situations can be for example pre-sale situations in which the machine is to be shown to a customer, the presentation of such a machine at a trade fair or the dissemination of advertising material. Alternatively and/or additionally, training and the like is also relevant. However, a visualization of a machine can also be appropriate in conjunction with the operation of an actually existing machine to which the visualization corresponds. Therefore, for example when monitoring a machine, it is possible to display operating parameters in conjunction with a visualization, which facilitates intuitive perceiving of the operating state of the machine, for example if the rotational speed of a specific drive axle of a machine is displayed in the spatial proximity to the representation of the drive axle in the visualization.

A visualization is understood in this context to be in particular a pictorial or visual representation of the technical system which represents external appearance of the technical system in broad lines. A reproduction in broad lines is to be understood in particular as meaning that a user skilled in the art can recognize what type of technical system it is; that is to say that for example he can recognize a conveyor belt as a conveyor belt. It is not absolutely necessary for him to recognize a quite specific type of conveyor belt, that is to say a quite specific model of a specific manufacturer, and assign it unambiguously. Instead, it is significant that the individual components of the technical system can be recognized and assigned with respect to their primary function.

### SUMMARY OF THE INVENTION

According to the prior art it was necessary to produce and configure such visualizations for technical systems on an individual basis. Although modern design tools such as CAD systems also produce visualizations which represent the external appearance of the designed object after a conclusion of a design, this requires the design process to be concluded. Particularly when marketing complex design systems, such as complex machines or entire production lines, this is actually generally not the case. In this context, there is often a need for visualizations which are already available before the design phase and which can be generated with an acceptable degree of expenditure.

Moreover, in the case of a visualization of the type in question the emphasis is on the intuitive perception of the figurative representation and not on the accuracy of technical details. In the case of an image which is generated from a design tool such as a CAD system, there will therefore nevertheless be a need for costly manual post-processing in order to define which technical details are to be represented and which are in fact not to be represented, in order to permit the user to perceive quickly and intuitively the information which is to be ultimately conveyed by the figurative representation.

It may therefore in particular be desired to emphasize a certain technical aspect of the technical system. This may be for example the automation of the technical system. The components of the technical system which are necessary for this can then be taken into account correspondingly in the visualization. For example, a detailed representation of the components of the technical system which are relevant for the automation is possible, and alternatively and/or additionally the components which are relevant for the automation can be represented to a greater degree of accuracy of detail than the other components of the technical system.

However, such individual visualizations of technical systems which are optimized according to specific criteria can in practice be produced only with a large degree of manual effort.

The system described herein is therefore based on the object of disclosing a method, a visualization device and a computer program product which simplify the visualization of the automation of a technical system.

The system described herein is based on the realization that complex technical systems can be divided into a plurality of modules of which the complex technical systems are composed, or include a plurality of modules. The modules may each in turn be a technical system or a part of a technical system which can be delineated in respect of function of the module within a relatively complex technical system. Therefore, the technical system which is to be visualized may be for example a packaging machine.

One of the modules may be a conveyor belt which conveys the goods to the packaging machine. A further module may be a feed device for packaging material. A further module may be a robot arm which packs the goods. A further module may be a further conveyor belt for transporting packed goods away. A technical system of this type would then be composed of four modules in this consideration.

Module type data objects are stored in a data storage device. The module type data objects are assigned to specific module types. The module types may be for example the “conveyor belt” module type, the “robot arm” module type and/or the “feed device” module type. The module type data objects contain module type data relating to the properties of the module types. The module type data contain the data which relate to a graphical representation of the respective module types.

The user then firstly selects the module types of the modules of which the technical system is composed, via a user interface.

With respect to the packaging machine, the user would for example select two modules of the “conveyor belt” type, a module of the “feed device” type and a module of the “robot arm” type. Of course, the user can also be led through the system or the computer program product in a multi-stage selection method for the selection of the corresponding module. Therefore, for example related module types can be combined to form groups, wherein firstly a selection of one module type group is made. It is therefore possible for example for the user to select the “robot arms” module type group and then select for example between robot arms with a different number of axes.

The data processing device can then generate a module data object which is assigned to the module. The module data object contains module data. Immediately after the generation of the module data object, which occurs on the basis of the module data type object which is assigned to the selected module type, the module data relates to the properties of the module type which is associated with the respective module, that is to say also the data relating to the graphical representation of the module type which is associated with the respective module.

On the basis of the module data, a data processing device then generates a visualization of the composed technical system.

This visualization is displayed to the user by a visualization device. The visualization device may be for example a display.

### DESCRIPTION OF VARIOUS EMBODIMENTS

The system described herein permits simple and intuitive production of a visualization as under discussion, in the way described above, without requiring the high degree of expenditure which is necessary according to the prior art. In this context, the method makes use of the fact that complex technical systems are generally similar with respect to their design composed of specific components, which are represented by the modules, with respect to the automation properties thereof. Therefore, the possibility of pre-defining module types from which the modules are selected, and of which modules in turn the technical system is “composed”.

The selection of the module types of the individual modules can then be assisted by virtue of the fact that visualizations of module types which are available for selection are displayed to the user. This permits an intuitive selection of the respective module types on the basis of their visualization. The selection can be carried out, for example, by touching a touch display at the location at which the visualization of the respective module is displayed. Alternatively and/or additionally, the selection can be made by a pointing device, such as for example a computer mouse. Alternatively and/or additionally, the selection can be made by virtue of the fact that the visualization of the respective module type is moved by “drag & drop” into a specific area of the visualization device. This specific area can be assigned in particular to a position of the module whose module type is selected, relative to other modules of the technical system. In this way it may be possible for example for the technical system to have a series of conveyor belts. These are arranged one behind the other. The user can select only the module types for the respective conveyor belts and at the same time move them into positions on the display which correspond to the respective position of the respective “conveyor belt” module in the chain of conveyor belts. For example, in this way the, in particular, spatial arrangement of the modules relative to one another in the visualization can be influenced by the user within the scope of the selection of the module types.

The visualization of a specific technical system is preferably assigned to a project. The method can provide that, before the selection of the module types by the user, a project type is first selected by the user. The project type can be, in particular, a project for visualizing the automation of a specific type of a technical system. In this context, project type data objects which contain project type data can be stored in a data storage device. The project type data contain in particular data relating to the modules and/or module types which are compatible with the respective project type.

The project type data can preferably also contain data relating to graphical representations of a type of a technical system to which the respective project type is assigned. In this way, the selection of the project type of the type of technical system can be made intuitive, in accordance with the selection of the module type described above, for example by touching a visualization of the respective project type which is made available for selection.

Therefore, for example after the selection of the “packaging machine” project type the selection of modules which are compatible with the project type can be made by the user. The project type data object which is assigned to the project type contains project type data which contain in particular data relating to the compatibility of the project type with module types. The data can contain for example information about how many modules are required for the respective project type, and from which module types the modules can be selected. In this way, the relevant data of the “packaging machine” project type can contain for example information to the effect that a module can be selected from a group of module types, wherein the module types of the group are conveyor devices which are suitable for a packaging machine. The project type data can also contain for example the information that this module is to be arranged at a specific position, for example at an end of the packaging machine. The selection can then be made for example in such a way that visualizations of the modules from the group of suitable conveyor devices are displayed to the user. The user can then select the suitable module type, for example a specific conveyor belt, from the conveyor devices. The selection can be made for example by virtue of the fact that the user moves the visualization of the module type by “drag & drop” into the position provided for the module to be selected, in a visualization of the technical system which relates to the respective project.

The module data and/or the module type data and/or the project data and/or the project type data can contain data relating to the compatibility and/or the spatial orientation capability of modules and/or module types with respect to other modules and/or module types.

It is possible that only certain module types are compatible with one another. With respect to the example of the packaging machine this can mean for example that a “conveyor belt” module type can be combined only with some specific further module types which are possible for other modules of the technical system or of the project. It therefore may be the case that a certain “robot arm” module type has to be used which is assigned to a “robot arm” type which is suitable for interacting with the relevant “conveyor belt” type.

Module data, module type data, project data and/or project type data can contain data relating to the spatial orientation capability of modules and/or module types with respect to other modules and/or module types.

The technical requirements of the technical system may require the modules to be oriented spatially in a specific way with respect to one another if they are combined to form the technical system. Information on this can be contained in the project data, project type data, module data and/or module type data. This makes it possible for the data processing device to use the information or data during the generation of the visualization. This may lead in particular to a situation in which the modules in the visualization are spatially arranged with respect to one another in a technically appropriate way, preferably without the user having to make corresponding specifications or inputs for this.

With respect to the example of a packaging machine as described above this may mean for example that the modules which relate to conveyor devices are arranged in such a way that the conveyed objects can be transferred from module to module in a technically appropriate way.

The visualization may be a spatial and/or perspective representation of the technical system. Such a spatial or perspective representation has the advantage that it is basically possible to consider the technical system from different directions. In this context the visualization device may have in particular a suitable user interface such as for example a touch display. Alternatively and/or additionally, a pointing device such as a computer mouse may serve as a user interface.

The method can provide for the visualization to be influenced by user inputs in such a way that in particular the perspective of the representation of the technical system can be changed by corresponding user inputs. This leads to a situation in which the visualization of the technical system can be considered from different viewing angles. This is advantageous in particular when specific partial aspects of the technical system or of the automation of the technical system, for example the automation of a specific conveyor belt of a packaging machine, are of interest to the user.

The method can provide that movements of components of the technical system are visualized within the scope of the visualization. In this way, it is possible for the viewer to perceive intuitively in particular the aspects of the visualization which relate to the automation. This may be used in particular in presentations for example to clarify methods of functioning of the technical system. It is therefore possible for example to represent the movement of a conveyor belt at a speed which is dependent on the rotational speed of a specific drive of the conveyor belt.

In this context it may be advantageous in particular if the movement of an element which is designed for interaction with an object and/or of an object which is moved by the technical system is visualized. In practice, the significant factor for the user of the technical system is often not to be able to track the movement of each element of the technical system, that is to say for example of a drive axle. Within the scope of the intuitive perception of the correct functioning of the technical system according to the regulations, it is often significantly more appropriate for the movements of such elements of the technical system which interact with objects and/or the movement of the actual objects which are moved by the technical system to be visualized. It is therefore possible for example to visualize the movement of a conveyor belt by representing in the visualization of the conveyor belt the movement of objects which are transported by the conveyor belt. Alternatively, the movement of the belt of the conveyor belt which serves to interact with the objects which are to be transported by the conveyor belt are represented in the visualization. Furthermore, the element of the technical system which is visualized in respect of movement of the element may be for example a tool and/or a manipulation device for moving objects, such as a gripper device. Such an element of the technical system may be in particular a component of a robot, in particular of a delta robot or of a SCARA robot.

Furthermore, data relating to the operation of a real technical system can be acquired and included in the visualization. This may be done for example by acquiring operating parameters on the real machine by sensors. The data processing device can then be connected to the control device of the technical system via a digital data connection, for example. The operating parameters can be displayed in the visualization. For example, quantitatively acquired values, for example of the current conveying speed of a conveyor belt, can be included in the display of the visualization. It is also possible here for parameters to be optionally included in a display and excluded from the display in response to a user input. Likewise, the method can provide that the operating parameters are included in the display if the operating parameters lie outside specific predefinable parameter ranges, for example in order to detect operational faults. It is also possible for warnings to be visualized, for example in that a module which is affected by an operational fault is highlighted visually, for example by displaying a warning with a corresponding signal color. It is also possible for example to use the color yellow and the color red to signal different severities of adverse effects. In an ideal typical case, it is possible in this way to produce a “digital twin” of the real technical system with respect to the functions which are to be monitored. It is therefore possible within the scope of the described method for example that information which is based on the data about the operation of the real technical system is displayed to a user in conjunction with the visualization on a visualization device. This permits the information to be perceived intuitively by the user. The information may be in particular diagnostic information and/or equipment information. It can be for example equipment information such as the manufacturer, the type, the serial number, a hardware version, a software version and/or an order number of a respective component of the technical system, for example of an electric motor. Data relating to this information can also be contained in particular in the module data and/or module type data, if appropriate also in the component data and/or component type data described below. Furthermore, the information can contain event-related information, such as for example a fault number and/or a downtime number. It is also possible that the information contains technical descriptions relating to the technical system, for example instructions for the exchange of a component of the technical system, for example stored as a pdf file or video file.

In this context, it is possible that the displayed information is based at least partially on data which is obtained via a data remote transmission device. This may involve for example data which is made available to the technical system by a manufacturer of a component and/or of a module. This data may relate in particular to fault recovery during operation of the technical system, of the modules and/or of the components.

The inclusion of data relating to the operation of a technical system in the visualization can permit, in particular in conjunction with the visualization of movements of the technical system, monitoring of an actually existing device in a way which can be perceived intuitively. It is therefore possible for the visualization of movement sequences of the technical system to be carried out on the basis of data which is acquired on the real technical device. This may make it possible for the viewer to intuitively perceive the operating situation of the technical system “at a glance”. It is therefore possible for the viewer to detect, for example straight away, whether a technical system is disrupted in operation, for example because parts of the technical system are idle or are not carrying out movements properly.

The data relating to the operation of the real technical device may be obtained in particular from a control device of an electric drive of the technical system. This may involve in particular a stored program controller. The data may be for example data relating to the operation of an electric drive or of a plurality of electric drives which act on the element of the technical system whose movement is visualized or the technical object whose movement is visualized. The data may be in particular data relating to a rotational speed, a speed, a position, an acceleration, an electrical parameter such as a current and/or a voltage and/or a temperature of an electric drive.

In this context, the module data and/or module type data contain in particular information relating to the context between the data which serve as a basis for the visualization and are obtained from the control device and/or relate to the drive and the movement which is to be visualized for the element of the technical system or of the object which is moved by the technical system. In other words, information indicating how the operating parameters of the drive which relate to the data which are included in the visualization are associated with the visualized movements is stored in the module data or module type data. This means for example that data relating to the relationship between the rotational speed of an electric drive of the conveyor belt and the belt speed which results from this rotational speed are stored in the module data or module type data of a module of the “conveyor belt” type. For example also data relating to the kinematics of robots such as for example delta robots and/or SCARA robots can also be stored in the module data and/or module type data. These data permit the movement of the robot, for example of a gripper device of the robot, to be visualized on the basis of data relating to the drives of the respective robot.

Through the visualization, it is possible to provide operator control elements which make it possible for the user to make interventions into the operation of a real technical device. In a way which is analogous to the inclusion, as described above, of data relating to the operation of a real technical device in the visualization, in particular by a data connection between a user interface and the control device, interaction of the user with the visualization of the technical system makes it possible to influence the control device. It is therefore possible for example to configure areas of the visualization as control buttons which can be used by selection using a suitable pointer device such as for example a computer mouse or a touch display. It is therefore possible for example for interaction with a component of the technical system, for example a module, to be carried out by the user. In this way, it is even possible to use the method for visualizing the automation of a technical system as a method for controlling the technical system.

It is therefore possible, for example, in a way which is analogous to the example, already described above, of a packaging machine, to select a conveyor belt by touching the area on a touch display on which the “conveyor belt” module is represented. It is then conceivable that a context-related menu is opened by the selection, the menu permitting the user to make various interventions into the operation of the conveyor belt. For example, the user can be provided with the possibility of reducing the conveying speed of the conveyor belt.

Furthermore, the module data and/or module type data can contain data relating to the programming of a control device of the technical system, for example a stored-program controller, in particular wherein these data are used for automated generation of a program code for the control. In this way, it is possible to use the proposed visualization method as a programming tool, which can be operated intuitively, for programming the control device of an actually existing technical device. This is then expediently done by virtue of the fact that, according to the method described above, the technical system is modeled in a virtual fashion, and in a further method step a program code which corresponds to this virtual modeling is generated for the control device.

Checking of a program code for a control device of a technical system can preferably also be carried out. The visualization method permits in this context in particular the checking of a program code which is generated with the support of the visualization method as described above. In this context, a result of the checking is advantageously included in the visualization. In this way, when considering the visualization, the user can intuitively perceive whether the generated program code will achieve the desired result. It is therefore possible for example to display, within the scope of the visualization, movement sequences which the generated program would bring about in the real technical device. The user can then decide whether the program will be expected to have the effect desired by him, with respect to the control of the real technical device.

One aspect of the automation of a technical system is the drive system or the drive systems of the technical system. Drive systems bring about the movements of the technical system which are necessary for the function. In this context, the drive systems are in turn composed of a plurality of components, such as control devices, motors and/or transmissions. Moreover, a component of such a drive system can be a software component which is executed by the control device during the operation of the technical system.

In practice, these components are frequently selected from the delivery programs of the respective manufacturers. These delivery programs include a plurality of different component types. A component type is therefore to be understood as being a specific identifiable configuration of a component of a drive system, for example a motor in a uniquely determined embodiment. Therefore, each component can be assigned precisely one specific component type, while a plurality of identical components are assigned to the same component type.

Therefore, in practice one of the tasks when developing a technical system includes selecting the components of the drive system for the technical system from a plurality of available component types.

In practice, this is generally not possible until the technical requirements which are made of the individual components of the drive system of the technical system are already known. In practice this leads to a situation in which the selection of the components from the available component types does not take place until a very late stage of the development process of the technical system. Moreover, this selection process entails a large expenditure of time and effort in terms of work which is to be carried out by comparatively highly qualified persons.

The method described above can be used to control intuitively an automated selection process of the components. In practice, this can mean that the selection of suitable components is carried out with the provision of assistance within the scope of the presented method. In practice, the necessary components of a drive system, for example an engine and a transmission, are selected by virtue of the fact that these components are specified by component data which are assigned to the respective components. The data may include for example the necessary power and the necessary torque of the engine as well as the required transmission ratio of the transmission. By the presented method, for example the data which are to be specified can be presented in the visualization and can be selectable by the user. A user can therefore intuitively select the respective component which he would like to specify, and specify the component for example in a manner supported by a context menu. Component type data objects which are stored in a data storage device are then searched through components by a search algorithm.

In this context, a component type data object is to be understood to be a data object which contains data of a specific component type to which the component type data object is assigned. These data are referred to below as “component type data”. The component type data may be for example the rotational speeds and torques of an engine type or the transmission ratio of a transmission type. In such methods, the data processing device compares the component data of the required components with the component type data of the component types which are available for example in the delivery program of a manufacturer of components of drive systems. The data processing device can then select the component types for the required components on the basis of this comparison.

The selection of the components of the drive system can, however, also be configured with a still higher degree of automation. This is possible in particular if the module data and/or the module type data relate to at least one module-type-specific performance feature, in particular where the performance feature is selected from:
a power indication which relates to the performance capability of the module when performing a specific appropriate function of the module, in particular a power indication relating to a conveying performance and/or a production performance,
a compatibility indication which relates to the compatibility of the module with another module and/or a component,
an indication about the number and/or respective function of the driven axles.

The power indication which relates to the performance capability of the module when performing a specific appropriate function of the module can be for example:
a minimum value of a mass of an object which is to be moved by the module. This may be for example the mass of an object which is to be transported on a conveyor belt, or the mass of an object which is to be moved by a pick & place device.
A minimum value of an acceleration and/or a speed of an object which is to be moved by the module.
A minimum value of an acceleration and/or a speed of an element of the module which is designed for interaction with an object. The element of the module which is designed for interaction with an object may be for example a manipulation device for moving the object, such as for example a gripper device. It may likewise be for example a tool for processing the object, such as for example a welding device.
The number of objects which are to be moved by the module per unit of time.
The number of movement cycles, to be carried out per unit of time, of an element of the module which is designed for interaction with an object. This may be for example the number of movement cycles per unit of time of a pick & place device, e.g. picks per unit of time.

A compatibility indication which relates to the compatibility of the module and/or module type with another module and/or a component includes in particular a listing of modules, module types, components and/or component types which are compatible with the module. The components and/or component types may therefore be for example control devices and/or types of control devices which are suitable for actuating the module and/or a module of the same type in such a way that the module can perform an appropriate task of the module. If the module and/or the module type is for example a picker and/or a specific type of picker, the compatibility indication can contain a listing of control devices and/or types of control devices which are suitable for pick & place applications.

The data processing device can then select the component type of at least one component of the drive system on the basis of the module data.

In contrast to methods described above in which the selection of the component types is carried out on the basis of the component data which are to be determined in advance through dimensioning, the data processing device now accesses module data which already describes the technical properties of the technical system in which the drive system is to be used. In contrast to the component data, the module data is generally already defined at the start of the development process.

After the selection of the module type of at least one module, the user is advantageously offered the possibility of adapting and/or adding to the module data of this module. It is therefore possible, for example after the selection of the “conveyor belt” module type, to adapt the conveying performance and/or the conveying speed of the conveyor belt to the requirements.

The module type data relating to the “conveyor belt” module type then contains for example information about the relationship between the “conveying performance” and “conveying speed” parameters, on the one hand, and “required drive performance” and “required rotational speed” on the other. The relationships which are stored in the module data then permit the module data to be used as a basis for making an automated selection of suitable component types for the components of the drive system by the data processing device.

The module type data and/or the module data can correspondingly contain module-type-specific calculation bases for the calculation of the technical requirements which are made of the components of the drive system of the module. The module-type-specific calculation bases are in particular qualitative or quantitative relationships between the quantitative and qualitative requirements which are made of the functionality of the module, in particular of the performance features of the module relating to the functionality of the module and the qualitative and quantitative requirements which are made of the performance features of the drive system and are necessary to satisfy these requirements.

The module-type-specific calculation bases may include mechanical relationships between at least one axle which is driven by an electric drive and one element of the module which is moved by the drive and designed for interaction with an object and/or one axle which is driven by an electric drive and an object which is moved by the module by the drive. This makes it possible that, during the selection of the at least one component type, quantitative requirements which are made of performance features of the component type are calculated and compared with the component type data of the component types in question. This makes it possible that, for example when the module is a conveyor belt which is intended to be able to move objects with a certain mass, at a certain speed and/or with a certain acceleration, within the scope of the selection of the at least one component type, it is calculated which requirements are being made of the maximum torque, the maximum rotational speed and/or the torque/rotational speed characteristic curve of an electric motor which drives an axle of the conveyor belt. The data which are calculated in this way can be compared within the scope of the selection process with module type data of relevant types of electric motors, in order to ensure that the selected motor type or the selected motor types are suitable for ensuring that the conveyor belt satisfies the desired requirements.

The quantitative performance features and the qualitative performance features of the module are to be understood as being in particular such performance features which have to be satisfied on the part of the module so that the module can satisfy a correct function of the module. Therefore, for example in the case of the “conveyor belt” module type the conveying performance and/or the conveying speed can be considered to be quantitative performance features. The quantitative performance features may be in particular technical variables which have to exceed or undershoot specific limiting values. The qualitative performance features are performance features which only have to be satisfied qualitatively. These include for example a specific splash water protection and/or a compatibility indication which relates to the compatibility of the module with another module and/or module type and/or a component and/or a component type.

In particular, the performance features of the module are distinguished by the fact that the performance features are related to the module in entirety and not merely to a component of the module. The performance features have the advantage that the performance features are generally already known in a very early stage of the planning of a technical system. That is to say the user can select the module type on the basis of the module type data relating to the performance features.

The module data and/or the module type data can contain information about the structural design of the module type. The information includes in particular data which relates to the number and properties of the drive axles of the respective module type. For example, the module type data can contain for example the information that a module has two driven axles. As a result, the component types of a corresponding number of components which are required for the respective axles are selected by a data processing device.

Furthermore, the module data and/or the module type data contain in particular module-type-specific calculation bases for calculating the technical requirements which are made of the performance features of the components of the drive system.

The component data and/or the component type data can relate to at least one component-specific performance feature, in particular wherein the performance feature is selected from:
an indication relating to the correct function of the component as part of the drive system, in particular the correct function of the component with respect to a driven axle,
an indication relating to the performance capability of a component during correct use of the component, in particular an indication relating to a rotational speed, a torque and/or a power level,
a compatibility indication which relates to the compatibility of the component with a module and/or another component.

The performance features of the components of the drive system can be quantitative and/or qualitative performance features of the component and/or of the component type of the drive system. A quantitative performance feature of an electric motor may be for example a maximum power level of the electric motor. A qualitative performance feature of a component may be for example the compatibility of an electric motor with a control device of a certain type.

An indication relating to the performance capability of a component during correct use of the component may be for example the transmission ratio of a transmission, the processor performance of a control device, a torque indication of an electric motor, in particular a maximum torque and/or a torque/rotational speed characteristic curve of an electric motor, a rotational speed indication of an electric motor, in particular a maximum rotational speed of an electric motor.

A compatibility indication which relates to the compatibility of the component with a module and/or another component includes in particular a listing of modules, module types, components and/or component types which are compatible with the component. The component and/or component types can be for example control devices and/or types of control devices which are suitable for actuating the component. If the component and/or the component type is for example a servomotor and/or a specific type of servomotor, the compatibility indication can contain a listing of control devices and/or types of control devices which are suitable for actuating this servomotor and/or a servomotor of the same type. If the component and/or the component type is a software component and/or a type of software component, the compatibility indication can contain a listing of control devices and/or types of control devices which are capable of running the same software component and/or a software component of the same type.

The module-type-specific calculation bases which are contained in the module type data or the module data then serve in particular to calculate, from the module-type-specific performance features, the requirements which are made of the performance features of the components of the drive system. In the case of the exemplary “conveyor belt” module type, this means that the requirement which is made of the “motor power” performance feature of the “electric motor” component of the drive system is calculated as a function of the “conveyor power” performance feature of the module. The selection of a component type with component-type-specific performance features that satisfy the requirements which are made of the corresponding performance features of the component can then be made by the data processing device.

The selection process can be configured in particular in such a way that a plurality of possible solutions are proposed to the user. The user can then select solutions proposed from the plurality. Alternatively and/or additionally, selected component types can be prioritized. The most suitable component types which are required to implement the drive, and which appear most suitable on the basis of defined parameters, are then for example proposed to the user. The parameters which are used for prioritization can be contained in the component type data. For example, the data can include costs of the components of the selected component types. This makes it possible to propose for example the most cost-effective solution.

In particular, if a plurality of component types are selected within the scope of the selection of the at least one component type, the compatibility of the component types with one another can be taken into account in the selection process in such a way that, if incompatibilities of individual component types with one another are detected, a renewed selection of at least one component type takes place. The method can provide in this context that iterative loops are run through until the compatibility of the selected component types with one another is ensured.

The method can provide that the user can select a selected component type and cause alternative component types for selection to be displayed. In an advantageous fashion, the method can then provide the possibility that the user selects one of the alternative component types instead of the originally selected component type. In particular, it is possible that the alternative component types only have to be compatible with the module and/or the module type, i.e. compatibility of the alternative component types with other selected component types does not have to be absolutely required at first. The method can in this case provide that, after the selection of an alternative component type a renewed selection of the remaining originally selected component types takes place, for example in order to ensure that the compatibility of the other selected component types with the component type which is selected by the user is restored.

In practical terms this can mean for example that four component types are selected for a module of the conveyor belt type. A component type relates to a type of an electric motor, a further component type relates to a type of a transmission, and a further component type relates to a type of a control device, and the last component type relates to a type of a software component. For design reasons, the user would, however, like to select a different type of transmission. The user can then bring about, for example through a suitable user input, a selection of alternative types of transmissions which are compatible with the conveyor belt. In this context, there is the possibility of the type of transmission which is selected by the user not being compatible with the type of the originally selected motor. In this case, a new selection method occurs for at least the component type which relates to the type of motor. This new selected component type relating to the type of motor must then be compatible with the transmission selected by the user. Depending on the compatibility of the further originally selected component types with the component type which has been selected by the user and/or the component type which has been subsequently newly selected for reasons of compatibility, it is possible, where appropriate, for further renewed selections of component types to take place until the four selected component types are compatible with one another again. The user then obtains as a selection the transmission type which is selected manually by him as well as types of motor, control device and software component which are compatible therewith.

The method can provide that the user is provided with the possibility of processing the module data after the selection of the module type. Therefore, for example after the selection of the “conveyor belt” module type, the user can be provided with the possibility of adapting the “conveyor power” performance feature. The module data of the respective component are accordingly modified.

The modification of the module data can relate here, in particular, as described above, to the performance features of the respective module. However, it is also possible for features which relate to design properties of the respective module to be adaptable. Therefore, there may be provision for example that the user can adapt the number of the driven axles of the respective module.

In any case, it is advantageous if calculation bases which are stored in the module data can be adapted. In this way, it is possible, for example when modifying the number of driven axles of a conveyor belt, to adapt the calculation basis for the motor power, required at the individual axles, as a function of the conveyor power of the conveyor belt.

The modification of the module data of the module results in a new module type. There can therefore be provision that a new module type data object is generated on the basis of the module data object of the module. This new module type data object can then be stored in the data storage device.

In this way, it is possible to continuously expand the database of predefined module types. This has the advantage on the part of suppliers of components for drive devices that customers can cause typical requirements of the devices and of the corresponding modules to be included in the module type data. In particular, if the requirements of the customer are generally similar with respect to the properties of the modules or in the best case even identical, a type of “self-learning effect” occurs which leads to module types which have a higher probability of corresponding precisely, or at least better, to the requirements of the customers of the respective module being specified to the customers for selection.

Of course, in this context it may be appropriate if the user also has the possibility of also processing the data relating to the graphical representation of the respective module.

In particular, in this context, it is possible that the project data, the module data and/or the module type data are linked to user accounts. This permits, on the one hand, an “intermediate status” to be stored during the execution of the method according to the system described herein. The method can in this way be interrupted and continued at a later time. In this context, it can be ensured, in particular, that no authorized users receive access to the databases which are processed by a specific user.

This can in practice mean for example that a customer receives a customer login with which he logs on to a data processing device which is operated by a component supplier. The data objects which are generated for this user by the data storage device can then contain an assignment to the respective user or user account.

This relates, in particular, to the project data objects, the module data objects and the component data objects. However, it may also basically be provided that module type data objects and/or project type data objects are linked to a user account. It is then possible that users can create and/or manage “their” module types and/or project types using this assignment by processing the assigned module type data objects and/or project type data objects. In this context, it is conceivable that the access to these data objects is limited and/or blocked for other users. In this case, a company-side access, in particular for the supplier of components, can nevertheless be made possible, in order to evaluate the module type data objects processed by users and therefore support for example market research activities.

The project data contained in the project data objects can contain, in particular, links to other data objects, and likewise they can contain data which has been adapted and/or can be adapted by the user, such as for example a project designation.

Furthermore, the method can provide the user with the possibility of specifying and/or processing component data and/or component type data. This is advantageous, in particular, in a case in which there are particular requirements of individual components of the drive system, which result from the user's sphere. It therefore may be the case for example that, owing to already existing planning and/or infrastructure, there are specifications which relate to the components of the drive system.

The specifications may concern for example size limitations for individual components. Likewise, it is possible that, owing to the limited performance capability of a power supply system, the power consumption of a specific component, for example of an electric motor, must not exceed a specific level. In this case, the specifications made by the user for the component data of the drive system are taken into account during the selection of the component types for the components of the drive system.

It is however also possible that, before the selection of the at least one component type for a component of the drive system by the data processing device, components or at least one component are/is specified by the user.

This may take the form, in particular, of the user selecting a component type for a component. This may be implemented for example by virtue of the fact that the user is given access to component type data objects so that the user selects, on the basis of the component type data stored in the component type data objects, the component type data object which is assigned to a suitable component type, after which a component data type object which is assigned to the component of the drive system whose type has been selected is generated on the basis of the corresponding component type data.

In practice this would mean that the user selects, from a specified selection of component types, a component which is in any case to be a part of the drive system.

In practice this may be relevant, in particular, when an already existing technical system is to be merely modernized. In this case there may be provision that individual components of the drive system are to be re-used—for example motors and transmissions—wherein other components of the drive system are to be renewed—for example a control device. In this case, the user would select the component types of the components which are to be retained.

Alternatively and/or additionally there may be provision that the user has the possibility of defining and specifying components of the drive system. This may for example appropriately be the case if, during the retrofitting, as already described above, of an already existing technical system, components are installed which are to be retained, where no corresponding component type data objects are assigned to these components.

This may for example be due to the fact that these components originate from other manufacturers than the components which are to be configured with the described method. Likewise, they may be comparatively old components for which, owing to the age of the components, there are no existing corresponding component type data objects. The components which are defined in this way by the user are correspondingly taken into account by the data processing device during the selection of the at least one component.

The specification of the components by the user can be done by virtue of the fact that a component data object which is assigned to the component is generated by the data processing device, for example in response to a corresponding user input. The component data object contains component data which can be correspondingly processed by the user.

The generation of the component data object can provide that access is made to an existing component type data object whose data is then correspondingly adapted by the user. In practice this can mean that the user firstly selects a component type which is similar to the component to be specified. For example, the user who would like to specify a specific electric motor can select an electric motor type with similar properties.

For example, the corresponding component data object is then generated from the component type data object which is assigned to the component type, and the user is provided with the possibility of adapting the component data of the component data object to the properties of the component to be specified. In practice, this can mean for example that, after the user has selected a motor type with properties which are similar to those of the motor type which is actually present, the user adapts the component data to the properties of the motor which is already present.

In a way analogous to the generation, as already described above, of new module types, it is also possible to define new component types for a later use, for example in other projects. This may be implemented for example by virtue of the fact that a component type data object is generated on the basis of the component data object which has been provided by the specification of a component by the user. The component type data object can be stored in the data storage device. In this way, a continuous expansion of the selection of the available component types can be implemented—in a way analogous to the learning process described above, at the module type level, and also at the component type level. Correspondingly, assignments to user accounts can also be made for the component type data objects, so that the self-defined component types are, where appropriate, protected against access by other users.

The component data and/or the component type data can be used to generate program code for programming a control device. In this context the control device can be a component of the drive system.

Such control devices can perform complex control tasks in a technical system, and in particular actuate a plurality of axles of a drive system, in particular also with coordination with one another. This generally requires programming of the control device in a way which is coordinated with the particular features of the respective drive system or the respective technical system. Corresponding information in the component data and/or the component type data permits corresponding program code for the programming of the control device—at least partially—in an automated fashion by a correspondingly programmed computer.

This can be done within the scope of the described method by virtue of the fact that the module data, module type data, component data and/or component type data are evaluated during the generation of the program code and the program code is generated as a function of the result of the evaluation. It is therefore possible for example for control parameters which are provided in the program code to be calculated on the basis of component data and/or component type data. The control parameters are then written into the corresponding program code.

The generation of program code can alternatively and/or additionally be carried out by providing and/or using component types which are selected with the present method and which relate to software components. In this context, such software components can in the simplest case form the program code.

For example, the software components can be, in particular configurable, control programs or modules for such control programs. The control programs can be specific to certain categories of module types. Therefore, a control program can for example be suitable for module types which are intended for pick & place applications.

It is also conceivable that the software components are intended to supplement other software components. Such software components can be for example specific to certain kinematics which are applied in certain module types or which describe the module types kinematically, for example gantry kinematics, belt kinematics, kinematics of a Delta robot and/or kinematics of a SCARA robot, if appropriate with a specific number of degrees of freedom. It is therefore possible for example for one module type to relate to a SCARA robot which is intended to implement pick & place applications. A first software component can in this case be a control program which is specific to pick & place applications, and a second software component can be intended to supplement the first software component and be specific to suitable kinematics for SCARA robots. Both software components permit a control device to be programmed in such a way that the drives of the SCARA robot can be correctly actuated in order to accomplish pick & place tasks with this.

Alternatively and/or additionally, software components can serve to implement basic drive operations. It is therefore possible for a software component to be designed for example to permit continuous movements of a driven axle, to provide a virtual leading axle of a machine, to synchronize and/or couple drives with respect to position and/or speed, and to monitor and/or regulate a temperature.

Alternatively and/or additionally, software components can also serve to perform complex drive control operations. Such software components can be for example the implementation of electrical cam disks, positioning profiles, e.g. for touch probe positioning, or the control of the movements of a technical system with a plurality of driven axles, for example a storage and retrieval machine.

In particular, the component data and/or component type data can contain predefined program code modules which are used during the generation of the program code. This is advantageous in particular when the program code modules are specific to the respective component or the respective component type.

Values for units of demand, which represent quantitatively demand, arising due to a module and/or a component, in the region of the control of the technical system or of the drive system, can be assigned to the modules, module types, components and/or component types. Values of the units of demand can be contained in the module data, module type data, component data and/or component type data.

In this way, the units of demand can relate to a quantitative performance demand in respect of the hardware of a control device, for example a processor speed, processor time and/or storage size. The refinement is based on the concept that modules of a specific type or components of a specific type give rise to specific expenditure with respect to their control. This expenditure has to be covered by a corresponding control device.

Depending for example on the complexity of a module, control devices with certain processor speeds and/or certain sizes of an internal memory may therefore be necessary in order to be able to control the corresponding module during correct use of the module. The units of demand can in this case be used for the selection of a sufficiently powerful control device by the data processing device.

For a practical example this may mean for a “conveyor belt” module type a value for units of demand which relate to the main memory of a control device is stored in the module type data. The value may be for example an empirical value as to how much memory is typically required in a control device for controlling a conveyor belt. The units of demand can then be a customary unit for the designation of such memory locations (e.g., gigabytes).

However, the units of demand can also relate to expenditure which arises when implementing the drive system. In particular, the units of demand can relate to programming expenditure, in particular when programming a control device of the drive system. Such units of demand can then relate in particular also to the costs of programming a control unit.

For a practical exemplary embodiment this means that the values of a “programming costs” unit of demand, which are assigned to the respective module or the respective component in the module data or component data thereof represent the costs which the respective module or the respective component brings about during the programming of the controller.

The method can provide that the component data is used to generate a component data list. The component data list can contain components of all the components, or of a selection of components, of the drive system. In this way, for example parts lists can be produced. In particular, component data relating to the costs of the components can be incorporated into the component data list. The component data lists make it possible to easily obtain an overview of the expected costs of the drive system.

In particular, in this context the cost data lists can also contain cost data which has been acquired on the basis of an evaluation of units of demand for a programming expenditure, for example such as is described above for the control device. In this way, a comparatively precise cost estimate for the drive system of the planned technical system can be obtained with comparatively low expenditure and already at a very early planning stage.

The method can provide that the visualization device is spatially remote from the data storage device and data can be exchanged between the data processing device and the data storage device and/or between the visualization device and the data processing device via a remote data transmission device. The exchanged data may be, in particular, component data, component type data, module data and/or module type data.

The term “spatially remote” is intended to mean here a distance which is so large that the visualization device and data storage device must in all cases be parts of different, individually usable technical systems. This may mean for example that the visualization device and data storage device are located in different rooms, in different buildings and/or at different sites. In this way, the visualization device and the data storage device may be for example parts of different computers. For example the data storage device may be part of a server and the visualization device may be part of a PC.

The remote data transmission device may be a wired remote data transmission device or a wireless remote data transmission device such as a WLAN. It is also possible for the remote data transmission to take place over a plurality of remote data transmission devices of different types, for example that a PC is integrated into a wired Intranet of a company via a WLAN, which wired Intranet is in turn connected via a public remote data transmission network to the wired Intranet of a further company, which in turn operates the server.

Which data are transmitted via the remote data transmission network is determined in particular by the location where the data processing takes place. According to the described method, it is basically possible to allow the data processing to take place for example on a server which can also include the data storage device. The server can then provide for example a software interface which is based on a software protocol which can be processed for example with an Internet browser. Such so-called web interfaces have the advantage that the user can access them without having to install specific software on the computer of the user for this purpose.

Alternatively, it is also possible to install on the computer of the user a computer program which executes the method which has been presented and described. This computer program would then access, via the remote data transmission device, the data stored in the data storage device. Such a solution provides the advantage that the configuration of the software interface via which the remote accessing of the data takes place is independent of the limitations of software protocols which can be processed by customary browsers. This can increase the speed and therefore the user-friendliness when executing the method which has been presented and described.

In this context, distributed storage of the data can also take place. It is therefore possible for example for component type data objects and module type data objects to be stored in a central data storage device which is operated for example by a component manufacturer, while the individual data objects assigned to a corresponding user account are stored by the user locally on a separate data storage device.

The combination of at least one data storage device, at least one data processing device and at least one visualization device can therefore provide a visualization system for visualizing the automation of a technical system, where the system is designed to carry out the method which is presented and described above.

The features which are disclosed in the present description and in the claims can be essential both individually and also in any desired combinations for the implementation of the invention in various embodiments of the invention. The invention is not limited to the described embodiments and can be varied within the scope of the claims and taking into account the knowledge of a relevant person skilled in the art.

1. A method for visualizing the automation of a drive system for a technical system composed of a plurality of modules, the method comprising:
a user selecting module types for the modules via a user interface;
assigning module type data objects to the module types, wherein the module type data objects contain module type data relating to a graphical representation of respective ones of the module types and wherein the module type data objects are generated by a data processing device and contain data relating to a graphical representation of the module type of the respective module;
storing the module data type objects in a data storage device;
the data processing device generating a visualization of the composed technical system based on the module data; and
displaying the visualization to the user with a visualization device.

2. The method as claimed in claim 1, wherein, in conjunction with of selecting module types, visualizations of module types are available for selection and are displayed to the user.

3. The method as claimed in claim 1, wherein project type data objects are assigned to types of technical systems and are stored in the storage device, wherein the project type data objects contain project type data, wherein the project type data contains data relating to compatibility of each of the project types with the module types, wherein the user selects a project type before selecting the module types.

4. The method as claimed in claim 1, wherein the module data, the module type data, the project data and/or the project type data contain data relating to assignment of module types to groups of module types which are compatible with project types, and wherein, during selection of the module types, the module types which are assigned to the group of modules which are compatible with the respective one of the projects are made available for selection to the user.

5. The method as claimed in claim 1, wherein the project data, project type data, module data and/or the module type data contain data relating to compatibility and/or spatial orientation capability of modules and/or module types in relation to other modules and/or module types.

6. The method as claimed in claim 1, wherein the visualization is a spatial and/or perspective representation of the technical system, and wherein the perspective can be controlled by the user.

7. The method as claimed in claim 1, wherein movements of an element of the technical system which is designed to interact with an object, and/or of an object which is moved by the technical system, are visualized within a scope of the visualization.

8. The method as claimed in claim 1, wherein data relating to operation of a real technical device is acquired for the visualization, in connection with visualization of the movements, and is included in the visualization.

9. The method as claimed in claim 8, wherein the data relating to operation of the real technical device is obtained from a control device of an electric drive of the technical system.

10. The method as claimed in claim 8, wherein information based on the data relating to the operation of the real technical device is displayed to the user in conjunction with the visualization on the visualization device.

11. The method as claimed in claim 1, wherein operator control elements which permit the user to make interventions into operation of a real technical device are provided by the visualization.

12. The method as claimed in claim 1, wherein the module data and/or module type data contain data relating to programming of a control device of the technical system, and wherein the data is used for automated generation of program code for the control.

13. The method as claimed in claim 1, wherein program code, which is generated in an automated fashion for a control device is checked and wherein a result of checking is included in the visualization.

14. A visualization system for visualizing the automation of a technical system, comprising:
a data storage device;
a data processing device coupled to the data storage device; and
a visualization device coupled to the data processing device, wherein the data storage device includes a non-transitory computer readable medium having software that, when executed by the data processing device, allows a user to select module types for modules of the technical system via a user interface, assigns module type data objects to the module types, wherein the module type data objects contain module type data relating to a graphical representation of respective ones of the module types and wherein the module type data objects are generated by the data processing device and contain data relating to a graphical representation of the module type of the respective module, stores the module data type objects in the data storage device, generates a visualization of the composed technical system based on the module data, and displays the visualization to the user with the visualization device.

15. A computer program product having a non-transitory computer readable medium containing software that, when executed by a processor, causes the processor to perform the following steps:
allowing user selecting module types for the modules of a technical system via a user interface;
assigning module type data objects to the module types, wherein the module type data objects contain module type data relating to a graphical representation of respective ones of the module types and wherein the module type data objects are generated by a data processing device and contain data relating to a graphical representation of the module type of the respective module;
storing the module data type objects in a data storage device;
generating a visualization of the composed technical system based on the module data; and
displaying the visualization to the user with a visualization device.
